(19) United States
(12) Patent Application Publication
(10) Pub. No.: US 2008/0004112 A1
(43) Pub. Date: Jan. 3, 2008

(54) Video Game Control and Interface

(75) Inventors: Andrew Pines, Chicago, IL (US); William Catino, Chicago, IL (US); Wen Jiun Yee, Chicago, IL (US); Joseph Sislow, Evanston, IL (US)

Correspondence Address: BANNER & WITCOFF, LTD., 1100 13th STREET, N.W., SUITE 1200, WASHINGTON, DC, 20005-4051, US

(73) Assignee: Cosmodog, Ltd., Chicago, IL (US)

(21) Appl. No.: 11/427,730

(22) Filed: Jun. 29, 2006

(51) Int. Cl. A63F 13/00

(52) U.S. Cl. 463/37

(57) ABSTRACT

An electronic bowling game includes a rotational input device that allows a user to modify one or more parameters of an electronic bowling ball. The direction of rotation associated with user input corresponding to the rotational input device is used to determine one or more corresponding actions or functions associated with the electronic bowling ball. A forward direction of rotation, for example, may launch the electronic bowling ball. A backward direction of rotation may cause the game to enter a spin mode. In spin mode, spin may be applied to the electronic bowling ball. Spin parameters may further be defined based on one or more characteristics of the rotational user input. Users may also engage in a trickshot bowling game that challenges a user to launch the electronic ball along a path matching a predefined target path.

### FIELD OF ART

The invention relates generally to a method and a system for interfacing with elements of an electronic game. Specifically, the invention relates to a system and method for controlling an element of an electronic game and parameters associated therewith.

### BACKGROUND

Video games have increasingly become more complex and realistic. For example, video game devices and manufacturers are constantly improving graphics technology to provide a player the illusion of realism. In the same vein, video game manufacturers have also attempted to make controls more realistic to provide an overall immersive experience of the user. For example, motion detection devices have been developed to allow a user's body motion and movements to control one or more elements of a video game. Similarly, boxing arcade games may include boxing glove input devices that registers a user's punches and swings in the game.

However, enhancing the realism of controls and user interfaces often also increases the complexity and difficulty of a game interface. In one example, a control panel may include numerous buttons to allow a user to control a variety of parameters associated with a fighter's movements in a fighting game. Each button may correspond to a different parameter such as the height of a kick or the strength of a punch. Using such a controller, players must learn and memorize the location, orientation and function of the multiple buttons in order to achieve success in the game. In many instances, players may be discouraged by such complexity in the control interface and be dissuaded from engaging in the game.

For the foregoing reasons, a game interface that provides both realism and simplicity is needed.

### SUMMARY

A method and system for providing realistic and understandable controls may be implemented using a trackball input system. The trackball input system may include a trackball and two or more roller sensors to detect rotational input. In video games involving a ball or other spherical element, the trackball may facilitate a user's understanding of the control system. Two roller sensors may be used to detect rotational movement of the trackball in two directions. In one or more arrangements, the axes of rotation associated with the two roller sensors may be perpendicular to one another. In addition, a support roller may also be used to provide stability and support to the trackball. The support roller may be positioned between a display screen and the trackball and oriented along an axis defined between a display screen, the trackball system and a user facing the display screen. Thus, the support roller may act as a guide to reduce deviations in rotating the trackball in a forward or backward direction.

According to another aspect, different directions of rotation of the trackball may correspond to different responses or functions of an element of a video game. For example, in an electronic bowling game, rolling the trackball forward at any time may indicate a command to launch an electronic bowling ball displayed in the user interface. Alternatively or additionally, rotating the trackball in a left or right direction may alter the position of the bowling ball along the foul line. Rotating the trackball in a backward direction or toward the user may indicate a desire to apply spin to the bowling ball. In particular, rotating the trackball in a backward direction may initiate a spin mode. In the spin mode, functions corresponding to various directions of rotation of the trackball may be modified. For example, when in spin mode, rotating the trackball in either the left or right direction modifies the spin of the bowling ball rather than adjusting the position of the bowling ball. A user may exit out of the spin mode by selecting an exit option. An angle of spin and speed of spin may be determined based on a magnitude and direction of the rotational input detected from the trackball input system. The speed of spin of the bowling ball, for example, may be set in accordance with the speed of the rotational input.

In another aspect, available functions or commands may correspond to particular directions of rotation or ranges of directions of rotation. For example, launching a bowling ball may be associated with a forward range of rotation. Thus, if a user's direction of rotation falls within the range of rotation, the electronic ball may be launched. Additional or alternative factors may be used to determine which available function or command corresponds to the user's input. For example, speed may be used to determine whether to register a user's input as a launch command or a spin function.

In yet another aspect, the game controls may establish threshold velocities of rotation in order to prevent accidental input of a command. Thus, a user may be required to rotate the trackball at a threshold velocity or greater in order to have the desired command registered. If a user wanted to launch the bowling ball, for example, the user may have to rotate the trackball at a speed of 2 rotations per second before the command is entered.

In yet another aspect, a trickshot bowling mode or game may be implemented. A trickshot game mode provides the user with a pre-generated target path. The user must then modify various parameters of the bowling ball in order for the bowling ball's actual path to match the target path. The target path may further be marked with indicators such as graphical icons. A user may earn points for hitting all the targets or, alternatively or additionally, a user may earn points per graphical icon in the bowling ball's actual path that the bowling ball hits. Other scoring and reward systems may also be used. The target path may be generated based on a set of randomly generated parameters and, alternatively or additionally, may be based on a difficulty setting selected by the user. The difficulty setting may also automatically adjust with each successful round.

These as well as other advantages and aspects of the invention are apparent and understood from the following detailed description of the invention, the attached claims, and the accompanying drawings.

### BRIEF DESCRIPTION OF THE DRAWINGS

The present invention is illustrated by way of example and not limited in the accompanying figures in which like reference numerals indicate similar elements and in which:

FIG. 1 illustrates a block diagram of a general computing device and associated peripherals in which various embodiments may be implemented.

FIG. 2 illustrates an exploded view of an input mechanism according to one or more aspects described herein.

FIG. 3A illustrates a signal diagram conveying sensor readings from two sensors according to one or more aspects described herein.

FIG. 3B is a table containing sensor reading pairs and corresponding counter functions according to one or more aspects described herein.

FIG. 4 is a diagram of an electronic gaming system and an orientation thereof according to one or more aspects described herein.

FIGS. 5A, 5B, 5C and 5D are diagrams of different directions of rotation of a user input device and corresponding effects on an electronic element of a user interface according to one or more aspects described herein.

FIG. 6 is a diagram illustrating input velocity thresholds for registering user input according to one or more aspects described herein.

FIGS. 7A and 7B are flowcharts illustrating a method for processing user input in an electronic game according to one or more aspects described herein.

FIG. 8 is a flowchart illustrating a method for implementing a bowling game according to one or more aspects described herein.

FIG. 9 is a diagram of an electronic bowling game user interface according to one or more aspects described herein.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

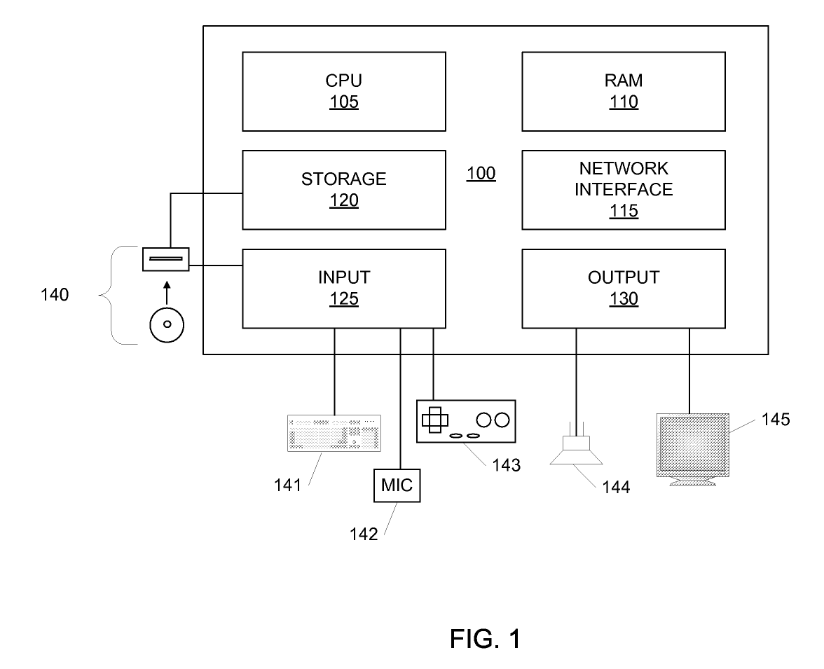

FIG. 1 illustrates a block diagram of a general purpose computing device 100 with associated peripherals 140, 141, 142, 143, 144 and 145 in which various aspects may be implemented. Computing device 100 may include multiple components 105, 110, 115, 120, 125 and 130 for providing numerous functionalities. A central processing unit (CPU) 105 is included in device 100 for performing computations, executing programs and applications and the like. CPU 105 may retrieve instructions from random access memory (RAM) 110 that provides temporary storage of program or application instructions that require processing by CPU 105. RAM 110 is generally faster to access than main memory such as storage 120. Read only memory (ROM, not shown) may also be included in device 100 for storing startup instructions for the memory, and other permanent instructions. ROM might not be changeable whereas RAM 110 may change contents depending on the currently executing application or applications. The ROM may further maintain its contents even after device 100 has been turned off. Storage 120 may include devices such as a hard drive, optical disks, flash memory and the like. Typically, storage 120 provides space to store applications, system files, content files such as videos and music as well as other types of data. Applications may be accessed from storage 120 and executed on device 100 using CPU 105. For example, application instructions may be generated by the application programming and stored to RAM 110 for execution by processor 105.

Device 100 may receive data and other input from a variety of sources including network devices (not shown) via a network interface 115. Network interface 115 may coordinate communications between device 100 and a network system or device (not shown) using networking protocols such as TCP/IP, UDP, SMTP, FTP and the like. Input may also be received through an input module 125 that manages incoming data from various sources such as optical disk drive 140, microphone 141, keyboard 142 and gamepad controller or control panel 143. The input interface 125 may include different ports for different types of input devices. For example, interface 125 may provide a Universal Serial Bus (USB) port for keyboard 142 which connects using a USB plug. Alternatively, an external optical disk drive like drive 140 may be connected to computing device 100 through a parallel port. In yet another arrangement, control panel 143 may send input signals to device 100 through an infrared port. Optical disk drive 140 may further provide storage capabilities and include a connection to storage unit 120 for external storage of data.

Further, device 100 may also output signals and data to one or more peripheral devices such as speaker 144 and display monitor 145. Audio signals from music or an audio track of a content file may be played through speaker 144. A video portion of the same or different content file may be simultaneously rendered on display monitor 145. Output module 130 may include a variety of interfaces and adapters to insure compatibility with output devices 144 and 145. For example, output module 130 may include a display adapter for providing the correct type and/or form of display signals to monitor 145. Output module 130 may further store control functions associated with output devices 144 and 145 such as volume control and brightness controls. In one or more arrangements, input received by input module 125 from control panel 143 may affect the rendering of one or more elements of a user interface displayed on monitor 145. For example, input from control panel 143 may control the movement and position of a bowling ball in a video game outputted on monitor 145.

While general computing device 100 has been described with respect to one specific embodiment, one of skill in the art will appreciate that a variety of configurations may be implemented.

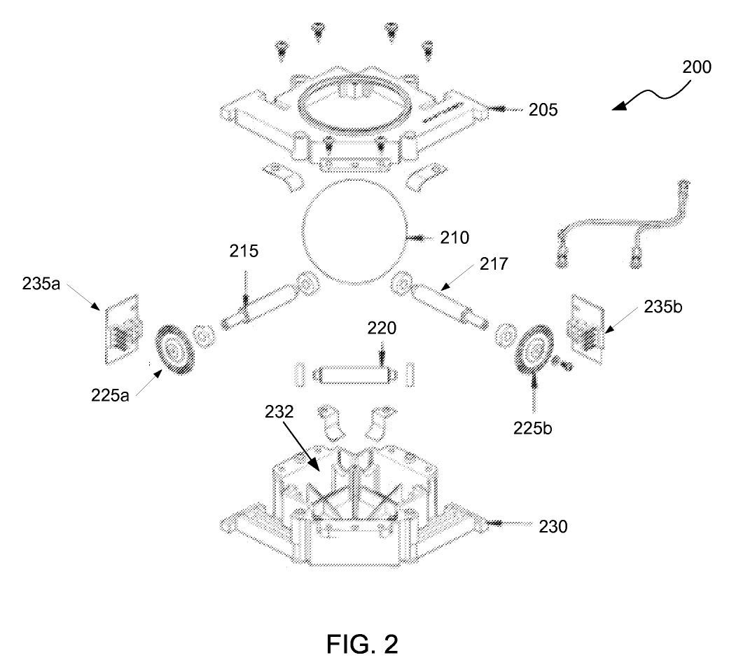

FIG. 2 illustrates an exploded view of a trackball user input system 200 that may be used to interface with a computing device such as device 100 of FIG. 1. The input system 200 may include multiple components such as a cover plate 205, trackball 210, one or more types of rollers 215 and 220, optical encoder wheels 225, a base plate 230 having a receptacle 232 and sensor boards 235a and 235b. The trackball 210 is generally a spherical member that is capable of rotation in numerous directions. To facilitate the rotation of trackball 210, multiple rollers 215, 215 and 220 may support trackball 210 from below. Rollers 215, 217 and 220 may further be mounted to base plate 230 to allow trackball 210 to nest in receptacle 232 of plate 230 while maintaining the trackball 210's range of motion and contact with rollers 215, 217 and 220. In addition, wheel members 225a and 225b may be attached to rollers 215 and 217, respectively, as a motion detection mechanism. That is, optical encoder wheels 225a and 225b may include multiple slots spaced along the outer circumference of each optical encoder wheel 225a and 225b. Thus, movement and one or more parameters associated therewith of rollers 215 and 217 and trackball 210 may be determined based on the appearance and disappearance of the wheel slots detected by opto couplers implemented on sensor boards 235a and 235b.

In one or more arrangements, sensor board 235a may determine a direction and displacement of motion associated with roller 215 using multiple opto couplers (not shown). For example, sensor board 235a may use two opto couplers that are spaced apart to detect wheel slots of optical encoder wheel 225a as it rotates and to determine a direction of motion based on the detection of the wheel slots. Using the sensor readings from each of the multiple opto couplers, a sensor board 235a and/or underlying computing device may determine whether motion is in a first direction or a second direction. Since optical encoder wheel 225a might only spin in two directions (clockwise or counter clockwise), sensor board 235a might only be responsible for determining rotation of trackball 210 in one of two directions. For example, if optical encoder wheel 225a were oriented in such a way that optical encoder wheel 225a registers rotation of trackball 210 in a left and right direction, sensor board 235a may only determine whether trackball 210 is rotating in a left direction or a right direction.

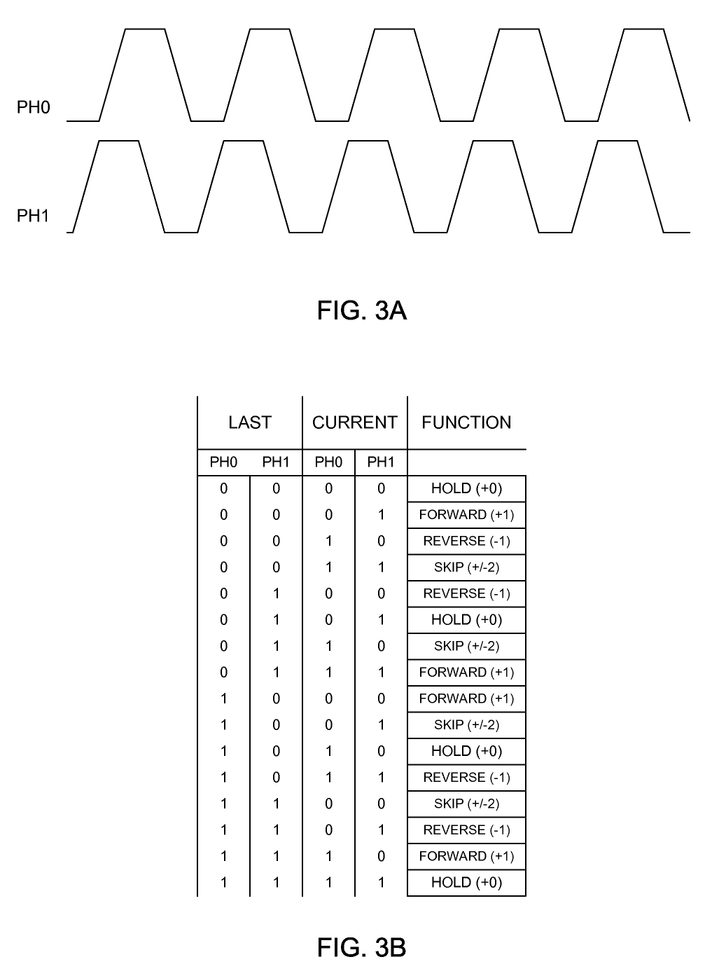

FIG. 3A illustrates a signal diagram showing sensor output from two opto couplers that may be identified as PH0 and PH1. The pair of opto couplers PH0 and PH1 is associated with a single sensor board such as board 235a or 235b (FIG. 2). In diagrams 301 and 302, each of opto couplers PH0 and PH1 registers a sequence of high and low values associated with the appearance and disappearance, respectively, of wheel slots of a wheel such as optical encoder wheel 225a of FIG. 2. In one or more arrangements, the low values may reflect the detection of a slot while the high values may reflect the detection of a blockage. Signal diagrams 301 and 302 are further plotted along the same time line. As such, since opto couplers PH0 and PH1 are spaced apart, a direction of movement may be determined based on the phase relationship between the output signals of PH0 and PH1. The phase relationship provides a mechanism through which a processor may determine whether the output signals of PH0 are lagging those of PH1 or vice versa. If corresponding signal values of PH0 are lagging those of PH1, a first direction of rotation or movement may be determined whereas if corresponding signal values of PH1 are lagging those of PH0, the reverse direction of rotation or movement may be determined. Thus, in FIG. 3, a processor may determine that the trackball is moving in a first direction based on corresponding output of PH1 lagging that of PH0. However, if corresponding signals from PH0 are determined to lag the signals of PH1, a processor may, conversely, determine that the trackball is rotating in a reverse direction.

FIG. 3B is a table showing a last input signal pair, a current input signal pair and a corresponding counter function. The table may be used to keep track of a signal counter that interprets a direction of motion associated with user input over a predefined amount of time. For example, a sensor board may detect several last input/current input pairs over a specified period of time. Thus, during the specified period of time, the sensor board may apply count modifiers, based on the multiple last input/current input pairs, to a signal counter that may represent an overall direction and/or magnitude of motion over the entire specified time period. The specified period of time may be arbitrarily determined or set based on the sensitivity of the opto couplers or sensors used. In one or more arrangements, for example, the sensor board may pass the signal counter to a processor or other device once every 1/60^{th} second using a sensor that takes 18000 readings per second. Preferably, sampling occurs at least 1000 times per second to prevent missing changes.

The table of FIG. 3B defines a set of correspondences between last input/current input pairs and a count modifier. For example, if the current value pair and the last input value pair shows no change in the sensor values, then no change is applied to the signal counter. In one example, the table may define the corresponding counter function as “add 0.” Alternatively, if the last input value pair and the current value pair shows a one step change, a predefined value, e.g., 1, may be added to or subtracted from the signal counter. A one step change may be defined as a change in only one of the two sensor values. For example, a one step change would be reflected by a change in value of PH0 from 0 to 1 while the value of PH1 remains constant. Whether the predefined value is subtracted from or added to the counter may depend on which sensor PH0 or PH1 detected the change. In other words, whether addition or subtraction is applied depends on the direction of rotation since the direction of rotation may be defined by which sensor value changes first.

In the event the transition from the last value pair to current value pair reflects a change of more than one step, a value greater than the predefined one step value, e.g., 1, may be applied to the signal counter. A change of more than one step may refer to instances where values of both sensors PH0 and PH1 change from the last input to the current input. The predefined value associated with changes of more than one step may be, e.g., 2. Whether the predefined value associated with changes of more than one step is subtracted from or added to the signal counter may be dependent on a direction of rotation associated with a previous last input/current input value pair. After the predefined period of time, the signal counter may then be transmitted to a processor to produce a corresponding result. For example, if the signal counter value is +50, an element of a video game interface may be spun in the forward direction with a force or speed of 50. In contrast, if the signal counter value is −20, the same element of the video game interface may be spun in the backward direction with a smaller force or speed of 20, instead.

A direction of motion is generally defined based on an orientation of a trackball system. In one or more arrangements, directions of rotation of a trackball may be defined based on an orientation of the trackball system with respect to a display screen associated with the overall gaming device. In one example, rotating a trackball of the trackball system toward the display screen may be considered a forward rotation while rotating the trackball away from the display screen may register as a backward rotation. The game interface may further define a left and right direction from the perspective of a user located at a position facing the display screen and such that the trackball system is positioned between the user and the display screen.

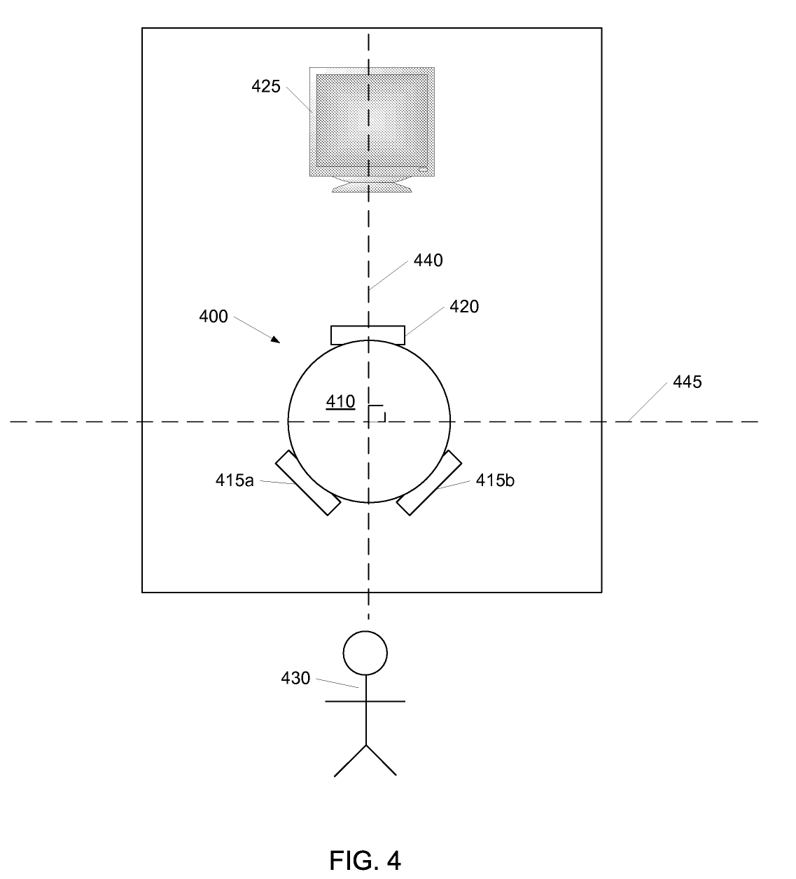

FIG. 4 is a diagram illustrating one orientation of a trackball system 400. Trackball system 400 may include similar components and have a similar configuration as trackball system 200 of FIG. 2. As with trackball system 200, trackball system 400 may include trackball 410 and multiple rollers 415a, 415b and 420 that contact trackball 410 to facilitate the rotation thereof. Rollers 415a and 415b may further include sensor mechanisms to detect rotation of trackball 410 in at least one direction. Roller 420 may be included to provide stable and balanced support for trackball 410, but might not include a sensor system. In one or more orientations, trackball system 400 may be placed between a user 430 and a display screen 425 so that a user may view display screen 425 while using trackball system 400. The display screen 425 may be used to display a graphical user interface (GUI) and register user input associated one or more elements of the GUI.

In addition, two directional axes 440 and 445 may be defined based on the orientation and positioning of user 430, display screen 425 and trackball system 400. Vertical directional axis 440 may be defined by an axis perpendicular to display screen 424 and intersecting trackball system 400 while horizontal directional axis 445 may be defined based on an axis intersecting trackball system 400 and perpendicular to the vertical directional axis 440. Each axis 440 and 445 may further be divided into a positive direction and a negative direction of motion or rotation. For example, a portion of horizontal axis 445 to the right of vertical axis 440 (when viewed from the perspective of user 430's position and orientation in FIG. 3) may be defined as a positive horizontal direction whereas the portion of the axis 445 to the left of vertical axis 440 may be defined as a negative horizontal direction. That is, rotations in the leftward direction of axis 440 may be expressed as a negative value whereas rotations or motions toward the right of axis 440 may be expressed as a positive value. Similarly, the portion of vertical axis 440 in front of or below horizontal axis 445 may be defined as a negative vertical direction while the portion behind or above axis 445 may be defined as a positive vertical direction.

Trackball system 420 may be oriented in such a way that roller 420 is positioned at the intersection of the axes 440 and 445, between display screen 425 and trackball 410 and parallel to horizontal directional axis 445. Additionally, the axis of rotation of roller 420 is perpendicular to the vertical axis 440. The position of rollers 415a and 415b may be defined based on an angular distance from roller 420. In one or more instances, the roller 415a is located at a distance from roller 420 equal to the distance between roller 420 and roller 415b. Further, rollers 415a and 415b may be oriented such that the axis of rotation of roller 415a is perpendicular to the axis of rotation of 415b. Alternatively or additionally, the position of rollers 415a, 415b and 420 may be defined based on an angular offset from axes 440 and 445. For example, the location of roller 415a may be identified as 45° from the negative portion of horizontal axis 445 and 45° from the negative portion of vertical axis 440. The position of roller 415b, on the other hand, may also be identified as 45° from the negative portion of vertical axis 440, but 45° from the positive portion of horizontal axis 445. Such a positioning of rollers 415a, 415b and 420 and orientation of the trackball system 420 as a whole may reduce deviation in the trackball 410's direction of rotation.

In one or more arrangements, the magnitude of rotation of sensor rollers 415a and 415b may each be translated into a magnitude of rotation along the vertical and horizontal axes 440 and 445, respectively. For example, using the positioning and orientation of rollers 415a, 415b and 420 described above, the magnitude of rotation in each of the directions of rotation of rollers 415a and 415b may be translated into magnitudes of rotation along horizontal directional axis 445 and vertical directional axis 440. Since each of rollers 415a and 415b are 45° from each of the horizontal and vertical directional axes 445 and 440, magnitudes of rotation along the vertical and horizontal axes 440 and 445 may be calculated according to the following equations:

$$\begin{matrix}dx = - \frac{( d1 + d2 ) \sqrt{2}}{2} ; and & ( 1 ) \\ dy = - \frac{( d1 - d2 ) \sqrt{2}}{2} , & ( 2 )\end{matrix}$$

wherein dx is a magnitude of rotation or displacement along the horizontal directional axis 445 and dy is a magnitude of rotation along the vertical axis 440. The variables d1 and d2 represent the displacement values determined by rollers 415a and 415b, respectively. The resulting value may be either negative or positive indicating whether the direction is a positive or negative direction of the corresponding axis 440 or 445. A direction of rotation may further be determined using the calculated dx and dy values. The direction of rotation may further be expressed in terms of an angular offset. For example, a direction of rotation of trackball 410 may be expressed as 225° from the positive horizontal directional axis 445.

According to one or more aspects, the direction, magnitude and speed of rotation of a trackball may be translated into different actions in, for example, an electronic video game such as bowling. In an electronic bowling game, the direction and magnitude of rotation of a trackball such as trackball 410 of FIG. 4 may determine whether the electronic bowling ball is launched, spun, moved left or right and the like. In one or more arrangements, a mode associated with electronic bowling ball actions may correspond to a direction in which the physical trackball is rotated. For example, if a user rotates a trackball forward or away from her, the forward rotation may indicate that the user wishes to launch the ball toward the pins. Alternatively, if the user rotates the trackball left or right, the direction of rotation may indicate to the game that the user wishes to adjust the horizontal position of the electronic ball.

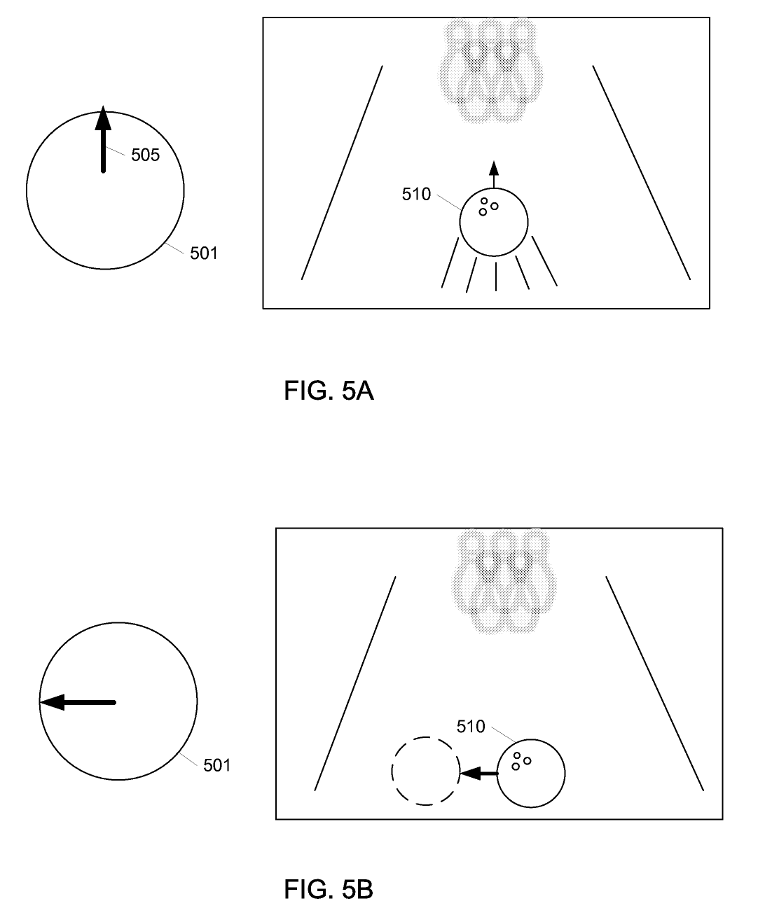

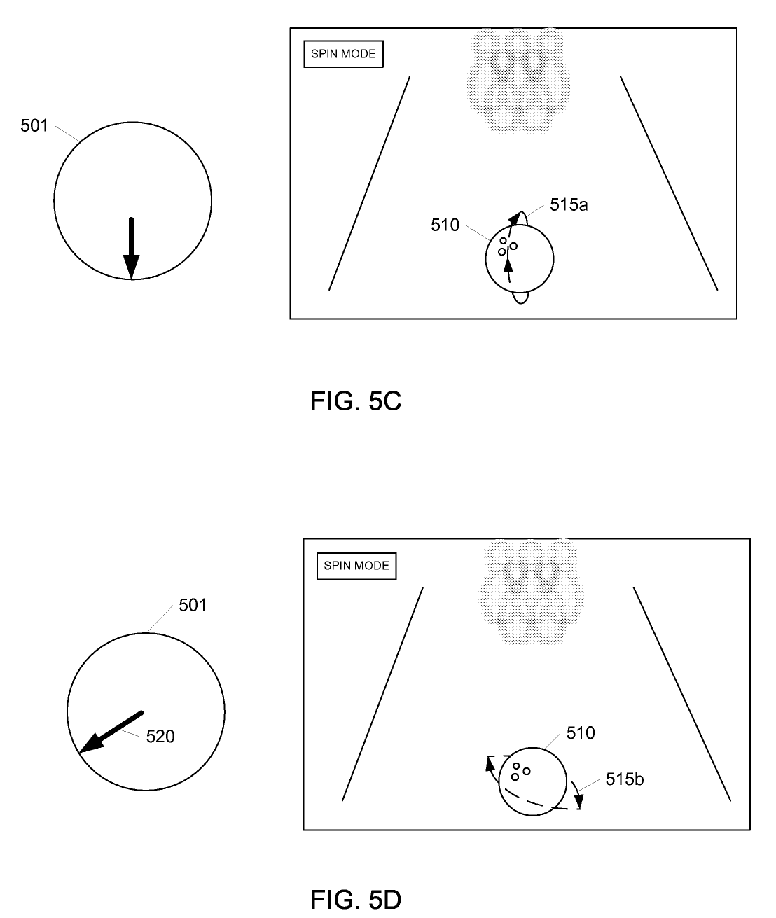

FIGS. 5A, 5B, 5C and 5D illustrate a variety of electronic ball actions corresponding to various types and directions of rotation of a trackball. In FIG. 5A, in response to a user rotating the trackball 501 in a forward direction 505, the electronic ball 510 may be launched in forward direction 505. The speed with which electronic ball 510 is launched may correspond to the magnitude and/or speed of rotation of trackball 501. In FIG. 5B, a user may rotate trackball 501 toward the left. In response, the video game interface may shift the position of electronic ball 510 toward the left. In FIG. 5C, a user may pull or rotate trackball 501 backward or toward the user. The backward rotation may indicate to the electronic game that the user wishes to initiate a spin mode or apply a spin to electronic ball 510.

According to one or more aspects, directions of rotation may be categorized into predefined ranges of directions corresponding to various actions or functions. In other words, a corresponding result or function may be determined based on whether a direction in which a trackball 510 is rotated falls within one or more predefined ranges of directions. For example, a game interface may associate a launch action or function with rotations in a 60°–120° range of directions, where 0° is directly to the right. Thus, rotations of trackball 510 in the 60°–120° range may register as a launch command. Similarly, a game interface may define a 160°–200° range of directions as a position shift command. In such an instance, a user's rotation of trackball 510 in, for example, a 175° direction may shift the position of an electronic bowling ball to the left. By defining action or function associations based on a range of directions, a user might not be required to rotate trackball 510 in a single specific direction to elicit the desired response or reaction. The predefined ranges may further be customized based on the function or action associated with the range of directions. In one example, a function for setting a linear velocity of the bowling ball may correspond to a 45° to 135° range of directions relative to the positive horizontal axis. In another example, a command associated with setting an angular velocity of the electronic ball may correspond to 253° and 283° range relative to the positive horizontal axis. Additionally, a function or command may be determined from a user's input based on a speed of the input in a particular direction (e.g., speed along the y-axis). Thus, a function or command might not be invoked if a user's speed of input in one or more directions does not meet a predefined threshold velocity. Alternatively, the system may determine a resultant action based on a component of a directional input, e.g., by analyzing a forward, reverse, left, or right component of a multidirectional input vector.

In one or more arrangements, by rotating trackball 501 in the backward direction, the electronic bowling game may enter a spin mode, locking out further manipulations to the position of electronic ball 510. In other words, once a user pulls trackball 501 backward to indicate a desire to enter a spin mode, rotating trackball 501 in either the left or the right direction might not register as a position shift action. Instead, as illustrated in FIG. 5D, rotating trackball 501 in a generally backwards range of motion while in spin mode may correspond to an adjustment of the angle and/or speed of spin of electronic ball 510. For example, a user may rotate trackball 501 in the direction indicated by arrow 520 while in spin mode. In response, the game interface may apply spin to electronic ball 510 based on the direction indicated by arrow 520. In particular, when applying spin to ball 510, the direction indicated by arrow 520 may be decomposed into a vertical directional component (i.e., backward component) and a horizontal directional component (i.e., left component). The vertical directional component may then be reversed such that a backward rotation of trackball 501 registers as a forward spin applied to ball 510. The horizontal directional component, however, may be applied without modification. This reversal of the vertical component allows a user to apply a top spin to ball 510 rather than a back spin. The applied spin may further be characterized by a speed determined based on a detected speed of rotation of trackball 501. Electronic ball 510 may then be launched as in FIG. 5A when applying the specified forward spin to ball 510. Additionally, arrows 515a (FIG. 5C) and 515b (FIG. 5D) may be displayed to indicate a direction, angle and magnitude/speed of spin of ball 510 to a user. For example, in FIG. 5C, arrows 515a indicate that ball 510 is rotating in a substantially forward direction. In FIG. 5D, however, arrows 515b convey a more leftward rotation. The magnitude and/or speed of spin may be indicated by a distance between ball 510 and arrows 515a and 515b. A variety of other types of indicators may also be used including stars, dashed line segments and music notes.

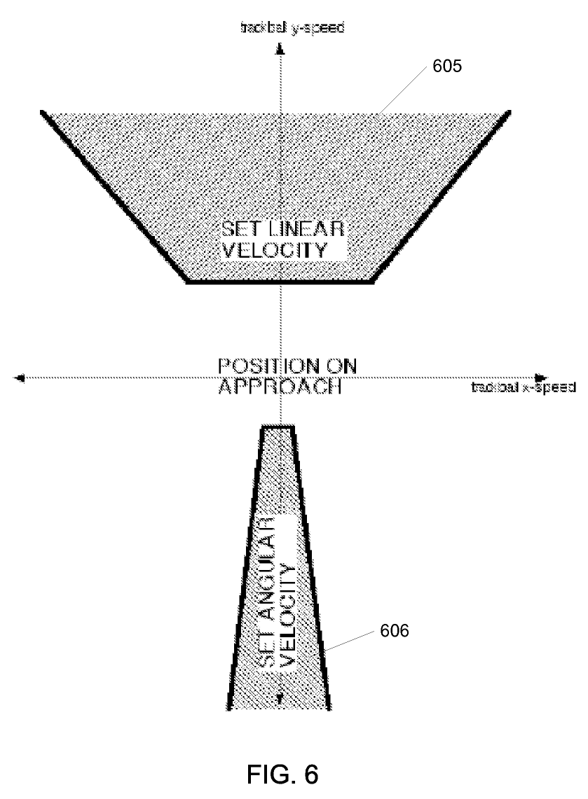

Alternatively or additionally, a game interface may define threshold velocities associated with rotating a trackball. In FIG. 6, two regions 605 and 606 are defined wherein input from a trackball is registered. However, if the velocity or speed of rotation of the trackball falls outside of the predefined regions 605 and/or 606, the input might not be registered. For example, a user may slowly rotate the trackball forward without confidence as to the effects. Since the forward rotation of the trackball does not reach the velocity region 605, the rotational input might not be registered by the game interface, i.e., the bowling ball is not “thrown” down the lane. Similarly, a user may cautiously rotate a trackball in the backward direction to test the outcome of such an action. Again, due to the low velocity of the rotation of the trackball, the user input might not register as a desire to enter spin mode. Various other regions may also be defined to reduce confusion and accidental input by new and/or experienced users.

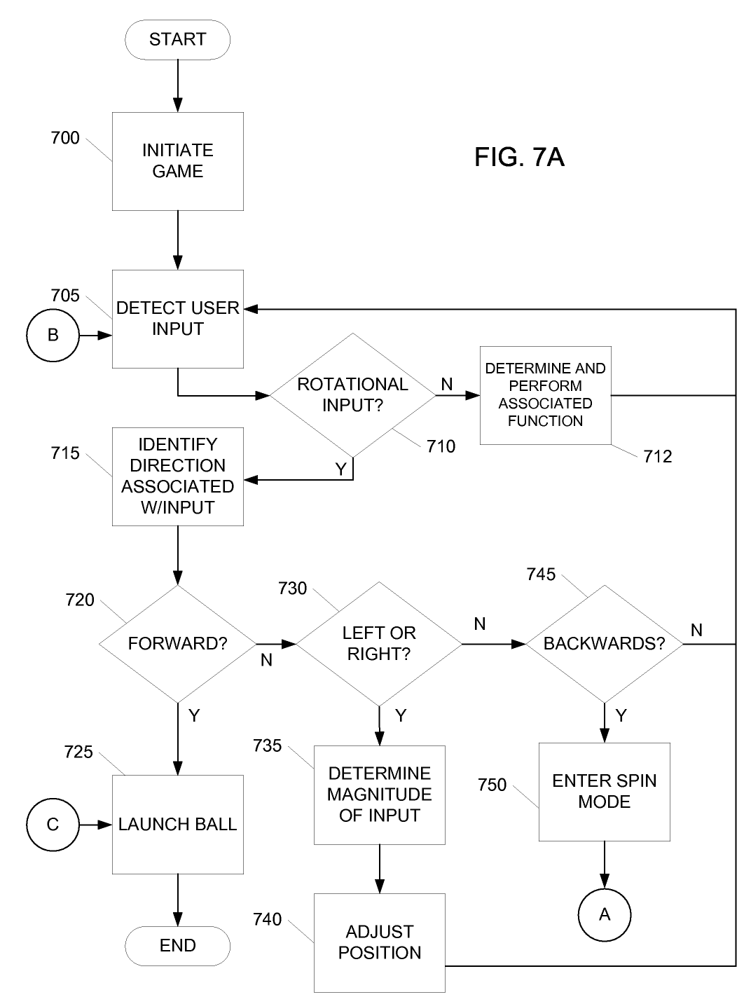

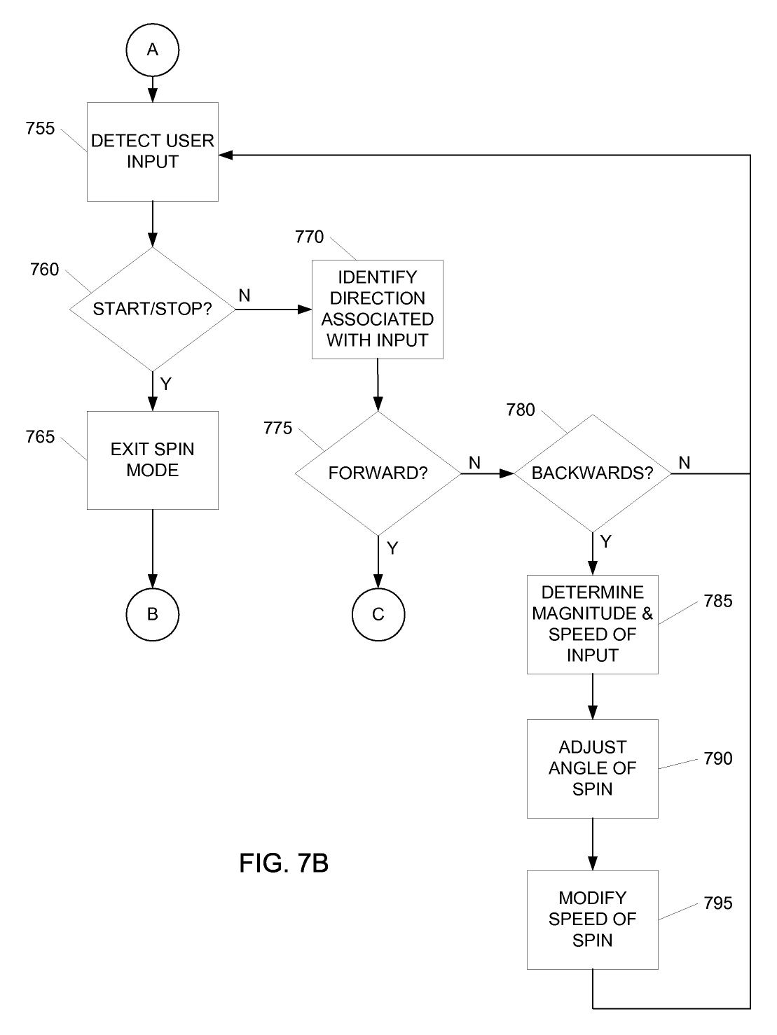

FIGS. 7A and 7B illustrate a method for processing user input in an electronic bowling game. In step 700, a user may initiate a game by, for example, selecting a game mode, inserting money and/or the like. In step 705, the game interface may detect user input. The user input may be inputted from a variety of different devices including buttons, trackballs, joysticks and touch screen displays. Thus, the game interface may determine whether the detected input corresponds to rotational input of a trackball in step 710. If the input does not correspond to input from a trackball, the game interface may, in step 712, determine and perform an action associated with the detected input. If the input does correspond to rotational input, however, the game interface may proceed by determining a direction of rotation associated with the input in step 715. In one or more instances, the direction of rotation may be determined by performing calculations on input data from rotational sensors. For example, input data may be translated into directional data associated with a particular set of axes. In step 720, a determination is made as to whether the determined direction corresponds to a forward range of directions. The forward range of directions may correspond to one or more predefined actions, e.g., launching an element of the game. If the determined direction does correspond to (i.e., fall within) the forward range of directions, an electronic element of the game interface such as an electronic bowling ball may, in step 725, be launched in the determined direction and with one or more parameters such as spin. If spin has not been applied or inputted, a set of default spin parameters may be applied instead. For example, the default spin parameters may set all spin values to zero.

If the determined direction does not correspond to a forward range of directions, a determination is subsequently made in step 730 to determine whether the direction corresponds to a left or right range of directions. For example, the determined direction may be compared against a predefined left or right range of directions. If the determined direction does correspond to either the predefined left or right range of directions, then in step 735, one or more characteristics, including magnitude, of the rotational input may be determined based on data associated with the detected input. In one or more arrangements, a magnitude of rotation along a particular axis, e.g., a horizontal axis, may be calculated to determine appropriate parameters in a resultant action. For example, the magnitude of rotation of a user's rotational input along a horizontal axis may be relevant in determining the amount by which the position of an electronic bowling ball should be adjusted in step 740. In another example, the speed of the user's rotational input may be used to determine a speed with which to adjust the position of the electronic ball.

If, however, the determined direction does not correspond to a forward range of directions or a left or right range of directions, a further determination is made to determine whether the determined direction corresponds to a backward range of directions in step 745. If the determined direction does correspond to the backward range of directions, then in step 750, the game interface may enter a spin mode. Entering a spin mode may cause other directions and/or types of inputs to be restricted. For example, upon entering a spin mode, the game interface might not register left and/or right rotations of a trackball or other input device as a positional shift request. In one or more arrangements, entering a spin mode modifies the correspondence between input direction and resultant actions or functions.

FIG. 7B illustrates a method for processing input upon entering a spin mode. In step 755, the game interface waits for and detects user input. In step 760, a determination is made as to whether the detected user input corresponds to a start/stop function (e.g., the user selects a ‘no-spin’ or ‘exit’ or similar button). If the detected user input does correspond to the start/stop function, then the game interface may exit the spin mode in step 765 and return to step 705. However, if the user input is provided via the trackball, a direction associated with the input is identified in step 770. If the identified direction corresponds to a forward range of directions in step 775, then the interface returns to step 725 where the electronic ball is launched, i.e., thrown down the lane.

Alternatively, if the identified direction does not correspond to the forward range of directions, but does correspond to a backwards range of directions in step 780 (e.g., includes a backward component, regardless of left/right direction of input), the game interface may further determine a magnitude and speed of rotation associated with the detected user input in step 785, based on the left, right, and/or backward components of the input. Using the determined direction, magnitude and speed of the detected input, a determined spin may be applied to the electronic ball in steps 790 and 795. In particular, the angle of spin of the electronic ball may be adjusted based on the identified direction in step 790. For example, in one or more arrangements, a backward component of the rotational input is reversed such that the backward component is converted into a forward spin component. Thus, instead of applying a back spin, a forward spin may be applied. Further, the magnitude and/or speed of rotation may be used to establish a speed of spin of the electronic ball in step 795. Once the spin has been applied to the electronic ball, a user may launch the ball by inputting a forward rotation. In response, spin parameters may be applied to the ball to determine a resultant trajectory or path. The resultant trajectory may be determined based on simulated laws of physics and corresponding computations. For example, coefficients of friction associated with different portions of a bowling lane may be used in the calculations. A linear velocity and angular velocity of the electronic bowling ball, as determined by the rotational input and spin parameters, may also be relevant to the trajectory calculations. In one or more instances, the significance or magnitude of spin may depend on the friction of the portion of the bowling lane. In one or more arrangements, the electronic ball is placed directly on a lane surface once the ball crosses the foul line. That is, loft might not be supported.

Once the electronic ball is launched, the electronic ball may encounter a number of variables associated with a simulated virtual environment such as a bowling lane. These variables may include one or more coefficients of friction associated with one or more sections of the simulated lane surface, and obstacles such as bowling pins. One or more laws of physics may be applied to the motions and interactions of the elements of the virtual environment based on the variables that are defined and/or applied to the environment and to the electronic ball. For example, a first portion of the simulated bowling lane may be oiled and thus have a low coefficient of friction. Thus, as the electronic ball is moving across this portion of the lane, an applied spin might have a lesser effect on the ball. In a second portion of the bowling lane, however, the coefficient of friction may be increased such that an applied spin has a greater effect on the ball and is registered based on the magnitude of the simulated friction between the ball and the lane surface. In another example, the reaction of one or more bowling pins may be defined based on a simulated weight distribution and position of each pin in relation to the ball (or other pins) upon contact.

Referring again to FIG. 7A, if, in step 745, it is determined that the determined direction of input does not correspond to a backwards direction, the input may be ignored or an instructional message may be displayed to the user. Alternatively or additionally, an error message may be displayed to the user in response to a non-registerable input.

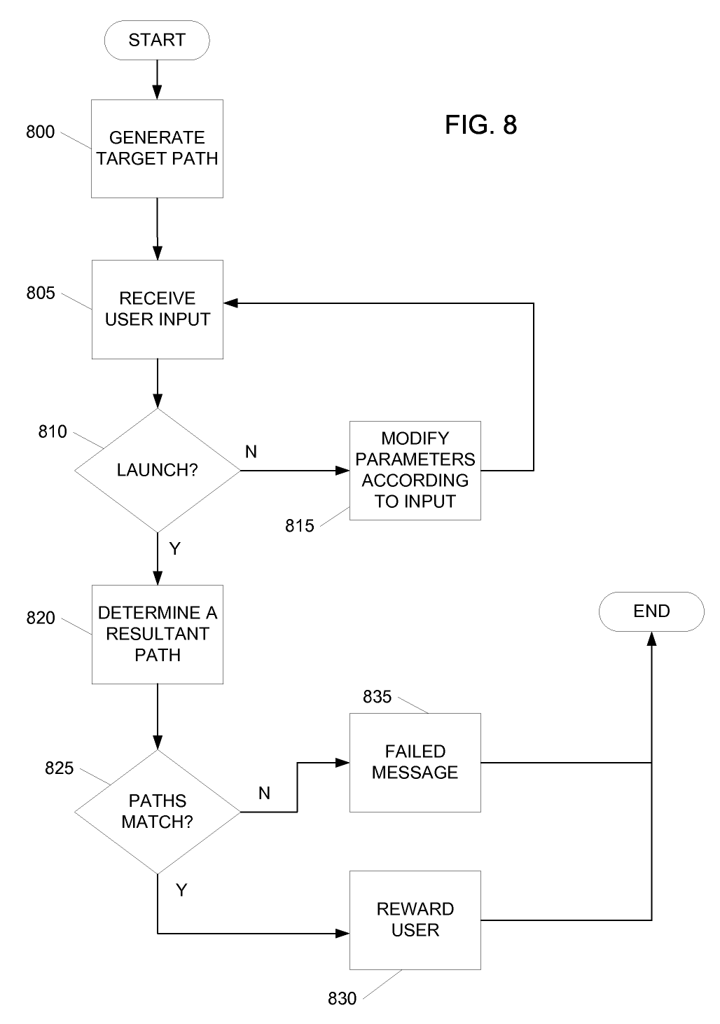

FIG. 8 is a flowchart illustrating a method for implementing a trickshot bowling game. In step 800, a target path is generated based on one or more parameters. For example, the parameters may include an angle and/or speed of spin that would launch an electronic ball along the target path. Other parameters may include variables such as a difficulty level. A set of points may be extracted or otherwise determined from the generated target path and set as targets with which the user attempts to intersect with a launched bowling ball. In step 805, user input may be received through a two-dimensional and/or rotational input device like a trackball. A determination is then made in step 810 as to whether the user input corresponds to launching the electronic ball. The determination may be made based on the direction of the user input. For example, a forward rotation of the user input device may correspond to launching the electronic ball. If the user input does not correspond to launching the electronic ball, one or more parameters of the electronic ball may be modified based on characteristics of the received user input in step 815. For example, a spin parameter may be applied to the electronic ball based on the direction and speed of rotation associated with the received user input. Additionally, a position parameter of the electronic ball may be adjusted by rotating the user input device in either a left or right direction.

If the user input does correspond to launching the electronic ball, a user path may be determined based on the parameters selected or inputted by the user in step 820. For example, a direction of launch may be determined based on the direction of the launch input (i.e., rotation of a trackball within a predefined forward range of directions)). In addition, spin parameters may be determined based on an applied angle and speed of rotation of the user input. Using various calculations and/or modeling protocols, a user path may be determined. In step 825, a determination is made as to whether the user path matches the target path. The determination may be performed based on whether the extracted or determined set of points associated with the target path matches a second set of coordinates associated with the user path. Some flexibility may be provided in the target path to reduce the level of difficulty in matching the target path. If the paths match, a user may be rewarded with points or other prizes in step 830. If the paths do not match, however, the user may be given a failure message in step 835. Alternatively or additionally, a user may be given advice on how to adjust the parameters of the electronic ball to better match the target path.

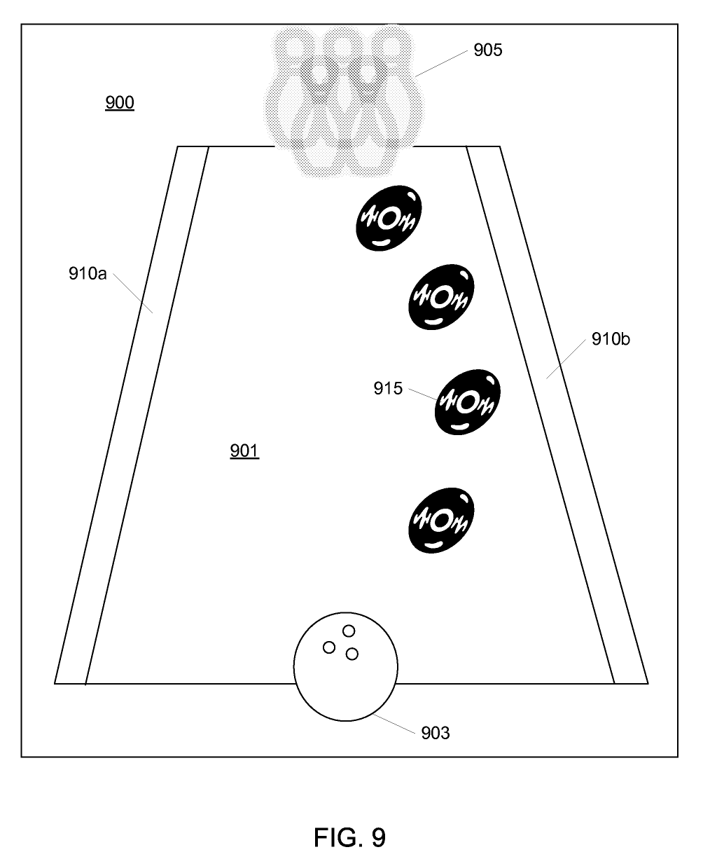

FIG. 9 illustrates a user interface 900 displaying elements of a trickshot bowling game. The trickshot mode or game may include a bowling lane 901, a bowling ball 903 and a set of pins 905. The lane 901 may be further characterized by two channels 910a and 910b (i.e., “gutters”). In a trickshot mode or game, interface 900 may generate a predefined target path for the user to achieve. The path may be marked by a series of graphical elements such as icons 915. Icon 915 provide a visual guide for a user to both prepare her shot and to determine whether ball 903 is on the right path once it has been launched. In one example, a user's score may depend on a number of icons 915 with which the ball 903's actual path intersects.

While the methods and systems described herein have been discussed with respect to trackballs and trackball input systems, any one of a variety of two-dimensional input devices may also be implemented. For example, a user may stroke a touch pad in one or more directions to elicit the responses and activate the functions described herein. In addition, various parameters of the touch stroke may be used to modify or defined parameters associated with an element of the interface. The speed of a stroke, for example, may be used to determine the speed with which an electronic bowling ball is launched. Other two-dimensional input devices include joysticks and mice.

The methods and features recited herein may further be implemented through any number of computer readable mediums that are able to store computer readable instructions. Examples of computer readable mediums that may be used include RAM, ROM, EEPROM, flash memory or other memory technology, CD-ROM, DVD or other optical disk storage, magnetic cassettes, magnetic tape, magnetic storage and the like.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A method for controlling an element of an electronic game interface, the method comprising:
detecting a first user input corresponding to a rotational input device;
identifying a first direction of rotation associated with the first user input;
determining whether the first direction of rotation corresponds to a request to apply spin to the element of the game interface;
in response to determining that the first direction of rotation corresponds to the request to apply spin, detecting a second user input corresponding to the rotational input device;
determining a second direction of rotation associated with the second user input; and
modifying one or more spin parameters associated with the element in accordance with the second direction of rotation.

2. The method of claim 1, wherein the first user input includes data associated with rotation in a first component direction and data associated with rotation in a second component direction.

3. The method of claim 2, wherein identifying the first direction of rotation is based on translating the first component direction and the second component direction to a third component direction along a predefined axis.

4. The method of claim 1, wherein the first direction of rotation corresponds to a backwards direction.

5. The method of claim 1, wherein the element of the game interface is an electronic bowling ball.

6. The method of claim 1, further including in response to determining that the first direction of rotation corresponds to the request to apply spin, preventing adjustment of a position of the element of the game interface.

7. The method of claim 1, wherein determining whether the first direction of rotation corresponds to a request to apply spin to the element of the game interface includes comparing the first direction of rotation to a range of directions.

8. The method of claim 1, wherein detecting a first user input corresponding to a rotational input device includes determining whether a velocity of the first user input meets a predefined velocity threshold.

9. The method of claim 1, wherein in response to determining that the velocity of the first user input does not meet the predefined velocity threshold, discarding the first user input.

10. The method of claim 1, wherein modifying one or more spin parameters associated with the element in accordance with the second direction of rotation further includes:
determining a speed of rotation associated with the second user input; and
modifying a speed of the spin in accordance with the determined speed of rotation.

11. The method of claim 1, wherein modifying one or more spin parameters associated with the element in accordance with the second direction of rotation further includes modifying an angle of spin associated with the element in accordance with the second direction of rotation.

12. The method of claim 1, wherein in response to determining that the first direction of rotation corresponds to at least one of a left direction and a right direction, modifying a position of the element in accordance with the first direction of rotation.

13. The method of claim 1, further including:
detecting a third user input corresponding to the rotational input device;
determining that a third direction of rotation associated with the third user input corresponds to a forward direction; and
in response to the determination that the third direction of rotation corresponds to the forward direction, launching the element in accordance with the one or more spin parameters.

14. A method for controlling an element of an electronic game interface, the method comprising:
detecting rotational user input corresponding to a rotational input device;
determining a direction of rotation associated with the rotational user input;
determining whether the direction of rotation falls within a predefined range of directions; and
in response to determining that the direction of rotation falls within a predefined range of direction, launching the element in accordance with only the detected rotational user input.

15. The method of claim 14, wherein the rotational input device includes a trackball.

16. The method of claim 14, wherein determining a direction of rotation includes determining one or more component directions of rotation.

17. The method of claim 16, wherein determining a direction of rotation further includes translating the one or more component directions of rotation into directions of rotation along one or more predefined axes.

18. The method of claim 14, wherein detecting rotational user input corresponding to a rotational input device includes:
determining a velocity of rotation associated with the rotational user input; and
determining whether the velocity of rotation meets a predefined velocity threshold.

19. An electronic game system comprising:
a display;
a user input device including:
a trackball,
a first roller sensor and a second roller sensor, and
a support roller, wherein the support roller, the first roller sensor and the second roller sensor facilitate rotation of the trackball;
a processor; and
memory storing computer readable instructions that, when executed by the processor, cause the electronic game system to perform a method including:
detecting a first user input corresponding to rotation of the trackball;
identifying a first direction of rotation associated with the first user input based on input data from at least one of the first roller sensor and the second roller sensor;
determining whether the first direction of rotation corresponds to a request to apply spin to an element displayed on the display;
in response to determining that the first direction of rotation corresponds to the request to apply spin, detecting a second user input corresponding to the trackball;
determining a second direction of rotation associated with the second user input; and
modifying one or more spin parameters associated with the displayed element in accordance with the second direction of rotation.

20. The system of claim 19, wherein modifying one or more spin parameters associated with the displayed element in accordance with the second direction of rotation further includes:
determining a speed of rotation associated with the second user input; and
modifying a speed of the spin in accordance with the determined speed of rotation.

21. The system of claim 19, wherein modifying one or more spin parameters associated with the displayed element in accordance with the second direction of rotation further includes modifying an angle of spin associated with the element in accordance with the second direction of rotation.

22. The system of claim 19, wherein a first axis of rotation of the first sensor roller is perpendicular to a second axis of rotation of the second sensor roller.

23. A method for implementing a bowling game, the method comprising:
generating a first path in a bowling lane displayed in a user interface;
receiving user input corresponding to actuation of an electronic bowling ball;
determining a second path of the electronic bowling ball based on at least one of a speed and a direction associated with the user input; and
determining a degree of correspondence between the second path and the generated first path.

24. The method of claim 23, wherein the generated first path is marked on the user interface by one or more graphical elements.

25. The method of claim 23, wherein determining a second path of the electronic bowling ball includes determining a spin associated with the electronic bowling ball based on the direction associated with the user input.

26. The method of claim 25, wherein determining the degree of correspondence between the second path and the generated first path includes comparing a first set of coordinates associated with the second path and a second set of coordinates associated with the first path.

27. The method of claim 23, further including determining whether the degree of correspondence falls within a predefined threshold of correspondence.

28. An electronic gaming device:
a display;
a processor; and
a user input device, including:
a first sensing roller and a second sensing roller, wherein a first axis of rotation of the first sensing roller is perpendicular to a second axis of rotation of the second sensing roller,
a support roller, wherein the support roller is positioned on a directional axis between the spherical member and the display, wherein the directional axis is defined by the display and the spherical member, and wherein each of the first sensing roller and the second sensing roller are a predefined distance from the support roller; and
a spherical member, wherein the spherical member is supported by the first sensing roller, the second sensing roller and the support roller.

29. A method for interfacing with an electronic bowling ball game, the method comprising:
detecting a first user input corresponding to rotation of a rotational input device;
identifying a first direction of rotation associated with the first user input;
determining whether the first direction of rotation corresponds to a backward rotation of the rotational input device;
in response to determining that the first direction of rotation corresponds to the backward rotation of the rotational input device, initiating a spin mode;
detecting a second user input during the spin mode;
identifying a second direction of rotation associated with the second user input;
determining whether the second direction of rotation corresponds to a forward rotation of the rotational input device; and
in response to determining that the second direction of rotation does not correspond to the forward rotation of the rotational input device, applying a spin to an electronic bowling ball in accordance with the second direction of rotation; otherwise,
in response to determining that the second direction of rotation does correspond to the forward rotation of the rotation input device, launching the electronic bowling ball.
